(19) United States
(12) Patent Application Publication
(10) Pub. No.: US 2005/0126868 A1
(43) Pub. Date: Jun. 16, 2005

(54) Brake dust cover structure of vehicle

(76) Inventor: Byung Kyu Lee, Whasung (KR)

Correspondence Address: MORGAN, LEWIS & BOCKIUS LLP (SF), 2 PALO ALTO SQUARE, PALO ALTO, CA, 94306, US

(21) Appl. No.: 11/009,986

(22) Filed: Dec. 10, 2004

(30) Foreign Application Priority Data
Dec. 10, 2003 (KR) 2003-0089527

(51) Int. Cl. F16D 55/02

(52) U.S. Cl. 188/218 A

(57) ABSTRACT

The brake dust cover structure of a vehicle prevents nearby components from being thermally damaged by insulating the brake disk from heat radiation and prevents impurities, such as pieces of stone, soil or the like, from entering into the brake disk along with air, thus preventing damage to the brake disk. The present invention further improves the cooling efficiency of the brake disk by maximizing the amount of airflow into the brake disk.

### CROSS-REFERENCE TO RELATED APPLICATIONS

The present application is based on, and claims priority from, Korean Application Ser. No. 10-2003-0089527, filed on Dec. 10, 2003, the disclosure of which is hereby incorporated by reference herein in its entirety.

### FIELD OF THE INVENTION

The present invention relates to a brake dust cover of a vehicle that is adapted to improve the cooling efficiency of a brake disk and to prevent impurities from entering into the brake disk.

### BACKGROUND OF THE INVENTION

Generally, a brake dust cover enclosing a brake disk is installed to prevent impurities from entering into a brake system. The brake dust cover prevents impurities from entering into the brake disk when the impurities enter along with the airflow. Further, the brake dust cover prevents heat radiation generated from the brake disk affecting neighboring components, thereby preventing the components from being damaged by the impurities and heat.

However, there is a drawback in the conventional brake system structure in that the brake dust cover wraps around most of the brake disk, deteriorating the heat emission of the brake disk due to the difficulty of air influx therein, and causing deterioration to the braking function by decreasing the cooling efficiency of the brake disk.

In order to improve the cooling efficiency of the brake disk, a brake dust cover has recently been developed to increase the air influx between the brake dust cover and brake disk. However, as the air influx increases in the above described structure, impurities that enter along with the air influx also increase. This causes corrosion and abrasion in the brake disk, as well as unwanted noise.

### SUMMARY OF THE INVENTION

An embodiment of the present invention is provided to improve the cooling efficiency of a brake disk and to prevent impurities from entering into the brake disk. A brake dust cover of a vehicle comprises a cover plate having a partially cut-off configuration for enclosing a brake disk. The cover plate is formed with an air inlet toward the front of the vehicle and is fixed to a knuckle. A guide part protrudes out toward the front and inner side of the vehicle and is configured to guide air from the front of the vehicle to the air inlet.

### BRIEF DESCRIPTION OF THE DRAWINGS

For a better understanding of the nature and objects of the present invention, reference should be made to the following detailed description with the accompanying drawings, in which:

FIGS. 1 and 2 are perspective views illustrating a brake dust cover structure of a vehicle according to a preferred embodiment of the present invention;

FIG. 3 is a rear view of the brake dust cover of a vehicle of FIG. 1;

FIG. 4 is a side view of the brake dust cover of a vehicle of FIG. 1;

FIGS. 5 and 6 illustrate a brake dust cover of a vehicle when installed at a knuckle according to an embodiment of the present invention; and

FIG. 7 illustrates a view that shows the operation of an impurity deflecting part.

### DETAILED DESCRIPTION OF EMBODIMENTS OF THE INVENTION

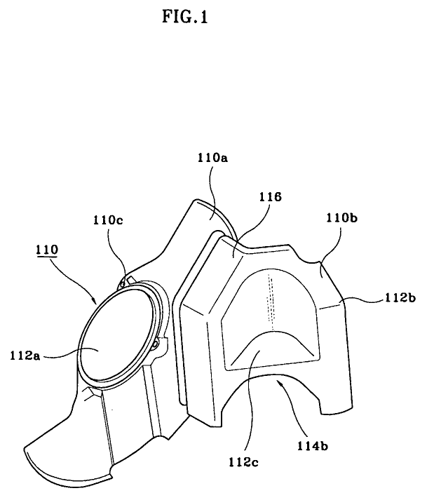

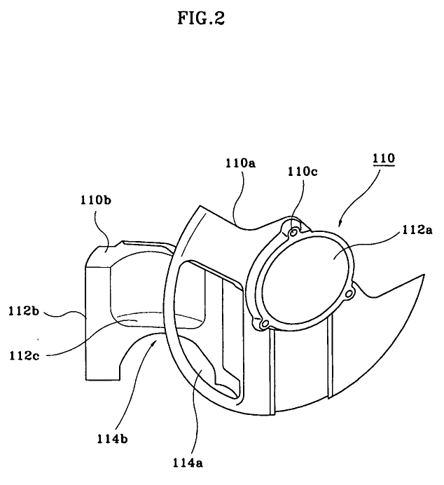

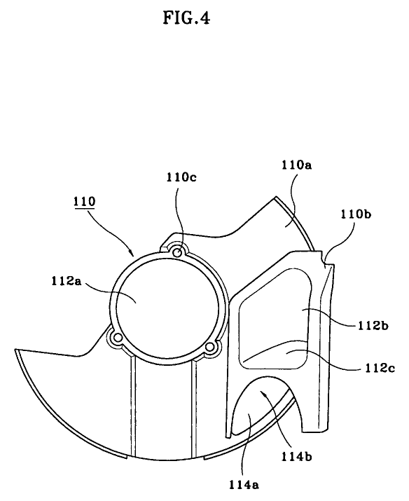

Referring to FIGS. 1 to 5, a brake dust cover 110 of a vehicle according to some embodiments of the present invention comprises a cover plate 110a and a guide part 110b. The cover plate 110a prevents nearby components from being thermally damaged by insulating the brake disk 120 from heat radiation. The cover plate 110a also prevents impurities (e.g., pieces of stone, soil or the like) from entering into the brake disk 120. The guide part 10b improves the cooling efficiency of the brake disk 120 by maximizing the amount of airflow into the brake disk 120.

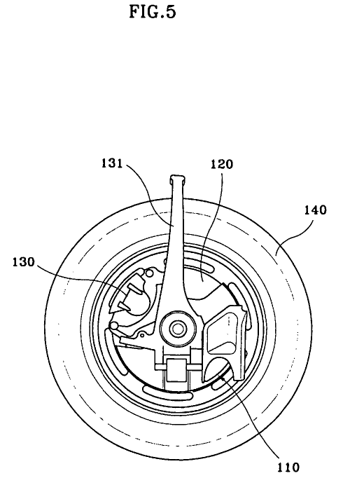

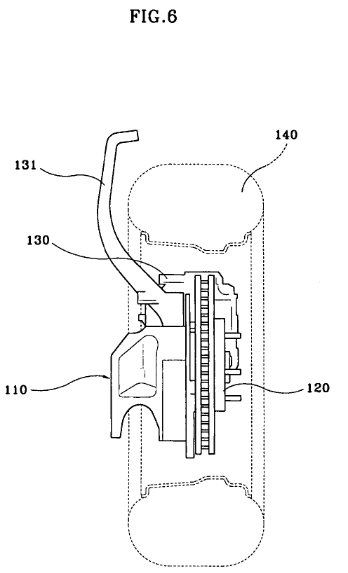

The cover plate 110a has a partially cut-off configuration. The middle of the cover plate 110a is formed with a hole 112a therein. An air inlet 114a is formed at the cover plate 110a toward the frontal direction of the vehicle for providing air between the cover plate and brake disk. The upper portion of the air inlet 114a is configured to be inclined downwardly toward the center of the cover plate 110a. The cover plate 110a is inserted into a knuckle through the hole 112a and is coupled to the knuckle via a fixing part 110c. The brake disk 120 is also coupled to the knuckle from the exterior toward the inner direction of the vehicle. By way of reference, the cover plate 110a is configured in a cut-off shape so as to prevent interference with the caliper and knuckle arm (see FIG. 5).

The cover plate 110a prevents nearby components from being thermally damaged by insulating the brake disk 12 from heat radiation. The cover plate 110a also prevents impurities such as pieces of stone, soil or the like from directly entering into the brake disk 120. The air inlet 114a formed at a lower right portion of the cover plate 110a improves the cooling efficiency of the brake disk 120 by reinforcing the airflow around the brake disk 120.

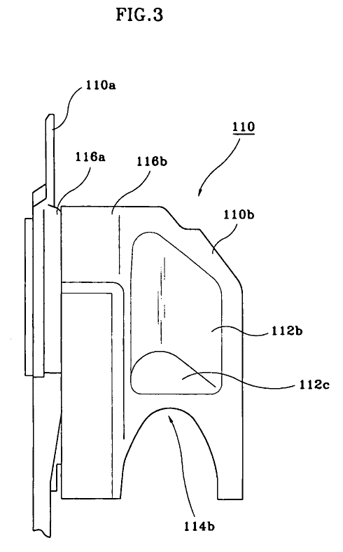

The guide part 110b is coupled to the cover plate 110a via a coupling part that is formed at the rear and upper portions of the air inlet 114a of the cover plate 110a. That is, the coupling part is constituted by overlapping flanges (116a and 116b of FIG. 3) formed at the cover plate and guide part, respectively. Once the coupling part is formed at either or both of the rear and upper sides of the air inlet, the guide part 110b may be coupled to the cover plate 110a. The guide part 110b induces air that flows from the front to the rear of the vehicle to smoothly be provided into the air inlet 114a.

The upper end frame of the guide part 110b is protrusively formed toward the front and inner side of the vehicle for maximally supplying air into the air inlet 114a, in which air flows from the front to the rear of the vehicle when the vehicle is in motion. An impurity deflecting part 112b is formed at an upper portion of the guide part 110b. The impurity deflecting part 112b protrudes out into a space formed between the guide part and cover plate for deflecting impurities to the inner periphery of the wheel, wherein the impurities are entered through the guide part. An impurity discharge part 114b having a downwardly opened groove configuration is formed at a lower portion of the impurity deflecting part 112b. The impurity deflecting part 112b and impurity discharge part 114b facilitate the discharge of impurities that are entered between the guide part and cover plate.

The upper end frame portion of the guide part 10b protrudes out toward the front and the inner side of the vehicle thus described. The upper portion of the air inlet 114a inclines downwardly toward the central direction of the cover plate. Accordingly, the air flowing from the front to the rear of the vehicle when the vehicle is moving is captured at the upper end frame portion of the guide part 110b and then smoothly flows into the air inlet 114a of the cover plate 110a.

In case the impurities are entered along with air, the impurity deflecting part 112b prevents the impurities from entering into the brake disk 120 by deflecting the impurities. The impurity deflecting part 112b includes a sloped surface 112c and is protrusively formed in a circular form toward the exterior of the vehicle, however, an ellipse or a polygonal form may be used instead.

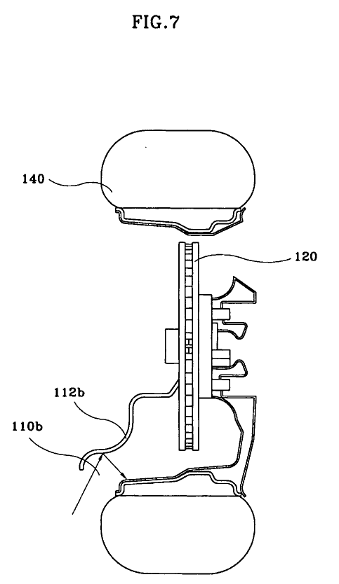

As illustrated in FIG. 7, impurities enter with air along the moving route (i.e., arrow direction) are bumped and deflected at the impurity deflecting part 112b. The deflected impurities by the impurity deflecting part 112b do not enter the brake disk 120 due to the change of its moving route; instead the impurities are mostly discharged through the impurity discharge part 114b after being bumped at the inner periphery of the wheel. The impurity discharge part 114b may be formed in an elliptical or a polygonal shape.

Thus, the impurity discharge part 114b facilitates the discharge of impurities entering between the guide part 110b and cover plate 110a. In addition, the impurity discharge part 114b induces the airflow via a lower arm installed at the rear of the guide part 110b or the like, thereby improving the cooling efficiency.

Typically, components adjacently installed to the brake disk 120 receive heat transmitted from the brake disk 120 and get thermally damaged. Accordingly, the impurity discharge part 1114b is formed at a lower part of the guide part 110b in the embodiment of the present invention for providing air to the rear side components through the impurity exhaust discharge 114b, when the air flows from the front to the rear of the vehicle. Therefore, the cooling efficiency of the rear side components of the guide part also improve. Reference numeral 130 refers to the caliper, reference numeral 131 refers to the knuckle arm, and reference numeral 140 refers to the wheel.

As apparent from the foregoing, there is an advantage in the present invention in that neighboring components of the brake disk are prevented from being thermally damaged by insulating the brake disk from heat radiation. There is another advantage in that impurities such as pieces of stone, soil or the like are prevented from entering into the brake disk, thereby preventing damage to the brake disk. There is still another advantage in that a maximum amount of airflow enters the brake disk, resulting in an improvement of the cooling efficiency of the brake disk.

1. A brake dust cover structure of a vehicle, the structure comprising:
a cover plate having a partially cut-off configuration for enclosing a brake disk, wherein said cover plate is formed with an air inlet toward the front of the vehicle and is fixed to a knuckle; and
a guide part protruding out toward the front and inner side of the vehicle, wherein said guide part is configured to guide air from the front of the vehicle to said air inlet.

2. The structure as defined in claim 1, wherein the upper portion of said air inlet inclines downwardly toward a central direction of said cover plate.

3. The structure as defined in claim 1, wherein said guide part is formed with an impurity deflecting part protruding out into a space formed between said guide part and said cover plate for deflecting impurities wherein said impurities are entered through said guide part.

4. The structure as defined in claim 3, wherein said impurity deflecting part is protrusively formed in a circular shape configuration.

5. The structure as defined in claim 3, wherein said impurity deflecting part is protrusively formed in an elliptical shape configuration.

6. The structure as defined in claim 3, wherein said impurity deflecting part is protrusively formed in a polygonal shape configuration.

7. The structure as defined in claim 3, wherein said impurity deflecting part includes a sloped surface.

8. The structure as defined in claim 3, wherein said guide part further includes an impurity discharge part having a downwardly opened groove shape configuration is formed at a lower side of said guide part.

9. The structure as defined in claim 8, wherein said impurity discharge part is formed in an elliptical shape configuration.

10. The structure as defined in claim 8, wherein said impurity discharge part is formed in a polygonal shape configuration.

11. The structure as defined in claim 1, wherein said cover plate includes a coupling part where at least one or both of the rear and upper portions of said air inlet couples with said guide part.

12. The structure as defined in claim 1, wherein said cover plate and said guide part are provided with flanges, respectively, and said cover plate and said guide part couple with each other by said flanges.

13. A brake dust cover structure of a vehicle, the structure comprising:
a cover plate having a partially cut-off configuration for enclosing a brake disk, wherein said cover plate is formed with an air inlet toward the front of the vehicle;
a guide part protruding out toward the front and inner side of the vehicle, wherein said guide part is configured to guide air from the front of the vehicle towards said air inlet;
an impurity deflecting part formed coupled to said guide part, where said impurity deflecting part protrudes out into a space formed between said guide part and said cover plate for deflecting impurities that enter said guide part.

14. The structure as defined in claim 13, wherein the upper portion of said air inlet inclines downwardly toward a central direction of said cover plate.

15. The structure as defined in claim 13, wherein said impurity deflecting part has a shape selected from a group consisting of: a circular shape, an elliptical shape, a polygonal shape and any combination of the aforementioned.

16. The structure as defined in claim 13, wherein said impurity deflecting part forms part of said guide part.

17. The structure as defined in claim 13, wherein said impurity deflecting part includes a sloped surface.

18. The structure as defined in claim 13, wherein said guide part further includes an impurity discharge part having a downwardly opened groove shape configuration is formed at a lower side of said guide part.

19. The structure as defined in claim 18, wherein said impurity discharge part has a shape selected from a group consisting of: an elliptical shape and a polygonal shape configuration.

20. The structure as defined in claim 13, wherein said cover plate includes a coupling part where at least one or both of the rear and upper portions of said air inlet couples with said guide part.

21. The structure as defined in claim 13, wherein said cover plate and said guide part are provided with flanges, respectively, and said cover plate and said guide part couple with each other by said flanges.
